(19) United States
(12) Patent Application Publication
(10) Pub. No.: US 2025/0062337 A1
(43) Pub. Date: Feb. 20, 2025

(54) ELECTRODE COMPRISING LITHIUM-RICH NICKEL MANGANESE OXIDES

(71) Applicant: GM Global Technology Operations LLC, Detroit, MI (US)

(72) Inventors: Colin Jamison, Livonia, MI (US); Jiazhu Hu, Lexington, KY (US); Bradley R. Frieberg, Farmington Hills, MI (US); Roland J. Koestner, Webster, NY (US); Nicole Ellison, Southfield, MI (US); Yuntao Gu, Farmington Hills, MI (US)

(21) Appl. No.: 18/451,163

(22) Filed: Aug. 17, 2023

(51) Int. Cl. H01M 4/525; H01M 4/04; H01M 4/505; H01M 4/62; H01M 10/0525

(52) U.S. Cl. CPC H01M 4/525; H01M 4/0404; H01M 4/505; H01M 4/623; H01M 4/625; H01M 10/0525; H01M 2004/021; H01M 2004/028

(57) ABSTRACT

A cathode for use in a lithium ion battery includes an active material present in an amount of from 70 to 99 weight percent, wherein the active material includes a lithium rich nickel manganese oxide; a conductive network of a mixture of conductive elements present in an amount of from 0.25 to 20 weight percent, wherein the mixture of conductive elements includes two or more of low aspect ratio particles, plate-like particles, and needle-like particles; and a binder system present in an amount of from 0.25 to 10 weight percent, wherein the binder system includes a primary binder polymer and an acid group or a salt thereof, wherein the amounts are based on a total weight of the cathode.

### INTRODUCTION

The subject disclosure relates to electrodes for lithium-ion batteries and the batteries having such electrodes.

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”). Typical lithium-ion batteries include at least two electrodes and an electrolyte and/or separator. One of the two electrodes serves as a cathode and the other electrode serves as an anode. A separator and/or electrolyte may be disposed between the negative and cathodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the anode and the cathode. For example, lithium ions may move from the cathode to the anode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the anode is effectively depleted. The battery may then be recharged by passing a suitable direct electrical current in the opposite direction between the electrodes.

The performance of a lithium-ion battery can decrease after the cycling of charging and discharging. For example, capacity loss can occur after cycling.

It would be desirable to have a battery that has high operating voltages and high reversible capacities that while having good cycling stability and reduced voltage decay.

### SUMMARY

In one exemplary embodiment, disclosed is a cathode for use in a lithium-ion battery, wherein the cathode includes an active material present in an amount of from 70 to 99 weight percent, wherein the active material comprises a lithium rich nickel manganese oxide; conductive network of a mixture of conductive elements present in an amount of from 0.25 to 20 weight percent, wherein the mixture of conductive elements includes two or more of low aspect ratio particles, plate-like particles, and needle-like particles, and a binder system present in an amount of from 0.25 to 10 weight percent, wherein the binder system includes a primary binder polymer and an acid group or a salt thereof. The amounts are based on a total weight of the cathode.

In addition, the cathode can include one or more of the features described herein. The lithium rich nickel manganese oxide can have the formula xLi₂MnO₃*(1-x)LiMO₂; wherein 0<x≤0.5, M includes Ni, Mn and optionally Co, and the mole ratio of Ni:Mn is in the range of 1:4 to 1:1.

The mixture of conductive elements may include the low aspect ratio particles in an amount 0.1 up to 10 weight percent, the plate-like particles in amounts from 0 up to 10 weight percent based on total weight of the cathode, and the needle-like particles in amounts from 0.05 up to 5 weight percent based on total weight of the cathode.

The cathode can include 90 to 99 weight percent of the lithium rich nickel manganese oxide based on total weight of the cathode.

The low aspect ratio particles may be carbon black, the plate-like particles may be graphene nanoplatelets, and the needle-like particles may be carbon nanotubes.

The low aspect ratio particles may have an average particle size of 2 nanometers to 200 nanometers and an aspect ratio of 2:1 to 1:1.

The plate-like particles may have a thickness in a range of from 5 nanometers to 100 nanometers and a dimension orthogonal to thickness in a range from 1 to 25 micrometers.

The needle-like particles may have a length of from 0.1 up to 100 micrometers, and an aspect ratio of 10 to 5000.

The active material may further include up to 60% by weight of one or more additional metal oxides or phosphates. The additional metal oxides or phosphates may include lithium manganese oxide (Li₍₁₊ₓ₎Mn₂O₄, where 0.1<x≤1) (LMO), lithium nickel manganese oxide (LiNi_{0.5}Mn_{1.5}O₄) (LNMO), lithium cobalt oxide (LiCoO₂) (LCO), lithium nickel manganese cobalt oxide (LiNi_{1-x-y}CoₓMn_{y}O₂) (where 0<x≤1 and 0≤y≤1) (NMC), lithium cobalt manganese aluminum oxide (LiNi_{1-x-y-z}CoₓMn_{y}Al_{z}O₂, where 0.0<x+y+z<0.25) (NCMA), lithium iron phosphate (LiFePO₄), lithium vanadium phosphate (LiVPO₄), lithium manganese iron phosphate (LiMn₁₋ₓFeₓPO₄, where 0≤x≤1) or a combination thereof.

A portion of the conductive elements may be functionalized with hydroxyl or carboxyl groups.

The primary binder polymer may include polyvinylidene fluoride.

The acid group may be carboxylic acid or sulfonic acid.

The acid group may be present in amounts of 0.05 to 10 milliequivalents per gram of binder system.

The acid group may be provided on an acid functional polymer distinct from the primary binder polymer.

The acid group may be present in an amount of 0.05 to 10 milliequivalents per gram of the acid functional polymer.

The binder system may include from 50 to 95 weight percent of primary binder polymer and from 5 to 50 weight percent of acid functional polymer based on total weight of the binder system.

The acid functional polymer may include an acid functionalized polymer polyvinylidene fluoride, (co)polymer or aromatic ionomer, sulfo-phenylated polyphenylene, a sulfonated derivate of poly(arylene ether), poly(arylene ether sulfone), poly(arylene sulfide), sulfonated polyimide, sulfonated polyphenylene, or combinations thereof.

In a particular embodiment the cathode includes 90 to 99 weight percent of the lithium rich nickel manganese oxide which has a formula Li[Li_{1/3-2x/3}NiₓMn_{2/3-x/3}]O₂ wherein 0<x<0.5, 0.5 to 5 weight percent of the primary binder polymer, 0.1 to 1 weight percent of an acid functional polymer, 0.05 to 1 weight percent of the carbon nanotubes, 0.1 to 5 weight percent of the carbon black, and 0 to 3 weight percent of the graphene nanoplatelets, wherein the weight percent is based on total weight of the cathode.

In another exemplary embodiment, disclosed is electrochemical cell including a disposed on a current collector, an anode disposed on an anode current collector and an electrolyte wherein the cathode includes an active material present in an amount of from 70 to 99 weight percent, wherein the active material includes a lithium rich nickel manganese oxide; conductive network of a mixture of conductive elements present in an amount of from 0.25 to 20 weight percent, wherein the mixture of conductive elements includes two or more of low aspect ratio particles, plate-like particles, and needle-like particles, and a binder system present in an amount of from 0.25 to 10 weight percent, wherein the binder system includes a primary binder polymer and an acid group or a salt thereof. The cathode in the electrochemical cell can include one or more of the additional features as described herein.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic side cross-sectional view of a cathode;

FIG. 2 is a schematic side cross-sectional view of an electrochemical cell of a battery having the cathode of FIG. 1;

FIG. 3A is a plot of capacity vs. cycles for the cathode formulations described in Example 1;

FIG. 3B is a plot of discharge retention vs. cycles for the cathode formulations described in Example 1;

FIG. 4 is a plot of voltage vs. capacity for a battery having a comparative cathode formulation;

FIG. 5 is a plot of voltage vs. capacity for a battery having a cathode formulation according to one example;

FIG. 6A is a plot of capacity vs. cycles for the cathode formulations described in Example 3; and

FIG. 6B is a plot of discharge retention vs. cycles for the cathode formulations described in Example 3.

### DETAILED DESCRIPTION

Lithium-rich active materials (LMR) for cathodes can provide high average operating voltages and high capacities but practical implementation of these has been challenging. One challenge is poor cycling stability (e.g., voltage decay and capacity decay during cycling). Various approaches to addressing these challenges have been proposed, including surface modification of the LMR with metal oxides, doping of the LMR, annealing of the LMR and managing morphology or structure. These complex approaches focus primarily on the LMR itself. It has been surprisingly discovered that selection of the formulation of active materials, binder and conductive elements of a cathode can be a simple and cost-effective approach to realizing the benefits of use of LMR materials while significantly improving the cycling stability (e.g., reducing the voltage decay and/or capacity decay).

The following description is merely exemplary in nature and is not intended to limit the present disclosure, its application or uses. It should be understood that throughout the drawings, corresponding reference numerals indicate like or corresponding parts and features.

The cathode as disclosed herein includes a lithium rich nickel manganese oxide active material, a mixture of conductive elements of different geometries which form a conductive network, and a binder system including acid functionality.

### Active Material

The active material includes lithium rich nickel manganese oxide. By lithium rich is meant that the molar ratio of lithium to other metals (e.g., nickel, manganese, and optionally an additional transition metal such as Co) in the active material is greater than 1:1, e.g., 1.1:1 to 1.49:1. For example, the lithium rich nickel-manganese oxide can be represented as xLi₂MnO₃*(1-x)LiMO₂; 0<x≤0.5 where M includes Ni and Mn wherein the mole ratio of Ni:Mn is in the range of 1:4 to 1:1. In one example, M consists of or consists essentially of Ni and Mn. In another example, M further includes an additional transition metal such as Co. Where such additional transition metal (e.g., Co) is present the ratio of additional transition metal:Mn can be less than 1:5 or less than 1:10. As another example, the lithium rich metal oxide can be represented by the formula Li[Li_{1/3-2y/3}Ni_{y}Mn_{2/3-y/3}]O₂ wherein 0<y<0.5.

The active material can be in the form of particles having an average particle size of from 0.5 up to 30 or up to 20 microns (i.e., μm or micrometers). Particle size can be measured, for example, by light scattering of a solvent dispersion using as Low Angle Laser Light Scattering (LALLS) or by electron microscopy of a dry powder or coating.

Optionally, in addition to the lithium rich nickel manganese oxide the active material can include one or more additional metal oxides or phosphates such as lithium manganese oxide (Li₍₁₊ₓ₎Mn₂O₄, where 0.1≤x≤1) (LMO), lithium nickel manganese oxide (LiNi_{0.5}Mn_{1.5}O₄) (LNMO), lithium cobalt oxide (LiCoO₂) (LCO), lithium nickel manganese cobalt oxide (LiNi_{1-x-y}CoₓMn_{y}O₂) (where 0≤x≤1 and 0≤y≤1) (NMC), lithium cobalt manganese aluminum oxide (LiNi_{1-x-y-z}CoₓMn_{y}Al_{z}O₂, where 0.0<x+y+z<0.25) (NCMA), lithium iron phosphate (LiFePO₄), lithium vanadium phosphate (LiVPO₄), lithium manganese iron phosphate (LiMn₁₋ₓFexPO₄, where 0≤x≤1), and combinations thereof. The amount of such additional metal oxides can be from 0, from 0.5, from 1, from 2, from 3, from 5, from 5 up to 60, up to 50, up to 40, up to 30, up to 20, or up to 10 weight percent based on total weight of the active material. The active material can be free of cobalt.

The active material can be present in the cathode in amounts of from 50, from 60, from 70, from 80, from 85, from 90, from 92, or from 95 up to 99 or up to 98 weight percent based on total weight of the cathode.

### Conductive Elements

The conductive elements include small particles of various geometries. Particularly, the conductive elements include particles of two or more of: small particles with low aspect ratios, plate-like particles, and needle-like particles. For example, the conductive elements are a binary mixture of small particles with low aspect ratios and needle like particles. In another example the conductive elements are a binary mixture of small particles with low aspect ratios and plate-like particles. In yet another example, the conductive elements are a binary mixture of plate-like particles and needle-like particles. In another example, the conductive particles can be a ternary mixture of small particles with low aspect ratios, plate-like particles, and needle-like particles.

The small particles with low aspect ratios may be substantially spherical, or may be irregular with aspect ratios of the longest dimension to the shortest dimension of 2:1 to 1:1, 1.5:1 to 1:1, or 1.2:1 to 1:1. For example, the small particles with low aspect ratio can be carbon black. The low aspect ratio particles, such as carbon black, can have an average particle diameter of from 2 nanometers up to 200, up to 150 or up to 200 nanometers. Particle size can be measured, for example, by Low Angle Laser Light Scattering (LALLS). The low aspect ratio particles can have a surface area in a range of from 10 to 500 square meters per gram (m²/g) and an electrical conductivity in a range of from 0.5 S/cm to 50 S/cm. The carbon black may be a furnace black with a surface area of approximately 45-65 m²/g in various implementations. Alternatively, the carbon black may be, for example, an acetylene black with a surface area of approximately 130-240 m²/g in various implementations. Alternatively, the carbon black may be, for example, another acetylene black with a surface area of approximately 280 to 320 m²/g in various implementations.

Surface area can be measured by, for example, the Brunauer-Emmett-Teller (BET) method.

Electrical conductivity can be measured, for example, by a 4-point probe measurement or by using a potentiostat to put various currents (I) in amps [A] into an electrode and measure the corresponding voltages [V]. Using Ohm's law, V=I*R, resistance (R) in ohms [Ω] can be calculated (R=V/I).

The plate-like particles can have a thickness of about 5 nanometers to 100 nanometers and dimension orthogonal to thickness of about 1 to 25 microns. For example, the plate-like structures can be graphene sheets or graphene sheet stacks having at least two graphene sheets stacked one on top of the other. Each graphene sheet is formed of a single layer of carbon atoms arranged in a honeycomb lattice. The graphene sheet stacks can be in the form of graphite flakes and can include greater than 10 graphene sheets or greater than 20 graphene sheets and up to 50 graphene sheets stacked one on top of the other. Alternatively, the graphene sheet stacks can be in the form of graphene nanoplatelets that have a discoid or lenticular shape and are made up of stacks of from 2 to 10 graphene sheets. The plate-like structures, such as graphene nanoplatelets, can have an aspect ratio of greater than or equal to about 20, or an aspect ratio of greater than or equal to about 100 up to 1000. The plate-like structures, such as graphene nanoplatelets, can have dimension orthogonal to thickness (e.g., diameter) in a range of from 1 to 25, or 2 to 10 micrometers and thicknesses in a range of from 5 nanometers to 100 nanometers. The plate-like structures, such as graphene nanoplatelets, can have a porosity of about 90%. The plate-like structures, such as graphene nanoplatelets, can have a surface area in a range of from 10 m²/g to 200 m²/g. The plate-like structures, such as graphene nanoplatelets, can have an electrical conductivity measured in a direction perpendicular to a major surface thereof of about 100 Siemens per centimeter (S/cm), and an electrical conductivity measured in a direction parallel to a major surface thereof of about 10⁷ S/cm.

Porosity can be measured by, for example, the Mercury Intrusion method. Surface area can be measured by, for example, the Low Angle Laser Light Scattering method.

The needle-like structures (e.g., having an aspect ratio (length:diameter or length:width) of greater than or equal to about 10, greater than or equal to 50, greater than or equal to 100, or greater than or equal to about 500, greater than or equal to about 1000, and up to 5000, or up to 3000. For example, the needle-like conductive particles can include carbon nanotubes. The needle-like conductive particles, such as carbon nanotubes, can have a substantially cylindrical cross-section in a direction orthogonal to the longest dimension (length). The needle-like conductive particles, such as carbon nanotubes, can have aspect ratios (length:diameter (or length:width if not cylindrical)) of greater than or equal to about 10, greater than or equal to 50, greater than or equal to 100, or greater than or equal to about 500, greater than or equal to about 1000, and up to 5000, or up to 3000. The needle-like conductive particles, such as carbon nanotubes, can have dimensions orthogonal to the length (e.g., diameter) in a range of from 0.5 nanometers to 50 nanometers and lengths in a range of from 0.1, from 0.5, from 1, from 2, or from 3 micrometers up to 100, up to 50, up to 20, or up to 10 micrometers.

The needle-like conductive particles, such as carbon nanotubes, can have a porosity of greater than about 97%. The needle-like conductive particles can be in the form of single-walled carbon nanotubes (SWCNT) and/or multiwalled carbon nanotubes (MWCNT). The needle-like conductive particles, such as carbon nanotubes, can have surface areas in a range of from 50, from 100, from 200, from 300, or from 400 up to 1300, up to 1000, up to700 or up to 500 m²/g and electrical conductivities in a range of from 102 S/cm to 106 S/cm. More particularly, the MWCNTs may have a surface area of, for example, 260 to 350, or 280 to 320 m²/g. The SWCNTs may have a surface area of, for example 380 to 420 m²/g. Bundling of the carbon nanotubes can reduce measured surface area.

Optionally, a portion of the conductive elements, for example, the carbon nanotubes can include one or more hydroxyl (—OH) functional groups and/or carboxyl (—COOH) functional groups, which may help uniformly disperse the carbon nanotubes throughout the entire thickness of the cathode.

The overall amount of the conductive elements in the cathode can be from 0.25, or from 0.5 or from 1 weight percent up to 49.8, up to 25, up to 20, up to 10, or up to 5 weight percent based on total weight of the cathode. The low aspect ratio particles, such as carbon black, can be present, for example, in amounts of from 0.1 or from 0.25 weight percent up to 10, up to 5, up to 3, or up to 2 weight percent based on total weight of the cathode. The plate-like conductive particles such as graphene sheet stacks can be present in amounts from 0, or from 0.1, or from 0.25 up to 10, up to 5, up to 3, or up to 2 weight percent based on total weight of the cathode. The needle-like conductive particles, such as carbon nanotubes, can be present in amounts from 0, or from 0.05, up to 5, or to 3, or to 1 weight percent based on total weight of the cathode.

As a particular example, the conductive elements can be 0.7 to 1 weight % carbon black and 0.5 to 0.7 weight % graphene nanoplatelets and 0.05 to 0.15 weight % singe-wall carbon nanotube (SWCNT) may be used in a ternary mixture based on total weight of the cathode. As another particular example, the conductive elements can be 0.25-1.5% multi-wall carbon nanotube (MWCNT) and 1.25-0% carbon black, respectively, may be used in a binary mixture.

### Binder System

The cathode includes a binder system. The binder system includes a primary polymeric binder. For example, the primary polymeric binder can include a primary polymeric binder such as polyvinylidene fluoride (PVDF) homopolymer or copolymer. The binder system includes acid functional groups or salts thereof. The acid functional groups may assist in dispersing of the other components of the cathode. Examples of the acid functional groups or salts thereof include carboxylic acid groups, sulfonic acid groups, and salts thereof. The acid functionality may be present in the binder system in amounts of 0.0025 to 3 milliequivalents (meq) per gram of binder system. The acid functionality can be provided by an acid functional polymer distinct from the primary polymeric binder. For example, the binder system can include 50 to 95, or 70 to 90 weight percent of primary binder polymer and from 5 to 50, or 10 to 30, weight percent of acid functional polymer based on total weight of the binder system. The amount of acid functionality on this acid functional polymer can be from 0.05 to 5 milliequivalents per gram of the acid functional polymer. The acid functional polymer can include acid functionalized PVDF homopolymer or copolymer, sulfo-phenylated polyphenylene (SPPP-H) and a sulfonated derivate of poly(arylene ether) (SPAE), poly(arylene ether sulfone) (SPAES), poly(arylene sulfide) (SPAS), sulfonated polyimide (SPI), sulfonated polyphenylene (SPP), or a combination of two or more thereof. The acid functionalized PVDF (co)polymer can be, for example, P(VDF (vinylidene fluoride): TFE (tetrafluoro ethylene): 4:1 w/w).

For example, the polymer binder system may include 95-50% polyvinylidene fluoride (PVDF) homopolymer with 5-50% acid functionalized PVDF (co)polymer or aromatic ionomer. The acid functionalized PVDF (co)polymer may be, for example, P(VDF (vinylidene fluoride): TFE (tetrafluoro ethylene):: 4:1 w/w) with approximately 0.10 to 0.15 meq carboxylic acid per gram polymer.

As another example, the acid functionalized polymer may have a different backbone composition and acid loading such as sulfo-phenylated polyphenylene (SPPP-H), with approximately 3 to 3.5 meq sulfonic acid per gram polymer.

The acid functionalized polymer may have, for example, a meq between approximately 0.05 and 10.0 per gram polymer.

The acid functionalized polymer may be, for example, one of sulfo-phenylated polyphenylene (SPPP-H) and a sulfonated derivate of poly(arylene ether) (SPAE), poly(arylene ether sulfone) (SPAES), poly(arylene sulfide) (SPAS), sulfonated polyimide (SPI), sulfonated polyphenylene (SPP), and combinations thereof, and one or more cations selected from H+, Li+, Na+, K+, and NH4+.

The binder system is present in the cathode in amounts of from 0.25, from 0.5, or from 1 up to 45, up to 20, up to 10, or up to 5 weight percent based on total weight of the cathode.

In a specific example, the cathode can be has 90 to 99 weight percent of the lithium rich nickel manganese oxide which has a formula Li[Li_{1/3-2x/3}NiₓMn_{2/3-x/3}]O₂ wherein 0<x<0.5, 0.5 to 5 percent of the primary binder polymer, 0.1 to 1 percent of an acid functional polymer, 0.05 to 1 percent of single wall carbon nanotubes, 0.1 to 3 percent of the carbon black, and 0.1 to 2 weight percent of the graphene nanoplatelets, wherein the percent is based on total weight of the cathode.

In another particular example, cathode has from 90 to 99 weight percent of the lithium rich nickel manganese oxide which has a formula Li[Li_{1/3-2x/3} NiₓMn_{2/3-x/3}]O₂ wherein 0<x<0.5, 0.5 to 5 percent of the primary binder polymer, 0.1 to 1 percent of an acid functional polymer, 0.05 to 1.5 percent of multiwall carbon nanotubes, and 0.1 to 3 percent of the carbon black wherein the percent is based on total weight of the cathode.

### Cathode and Method of Forming Cathode

The cathode can be formed by combining the active material, the conductive material, and the binder system in a solvent and coating that mixture onto a substrate. The substrate can be a current collector for the cathode. The coating is dried to form the cathode. For example, the conductive materials can be combined with a solvent such as N-methyl pyrrolidone (NMP) and agitated for a time such as 5 to 15 minutes. The binder system can then be added with additional agitation of 2 to 10 minutes. The cathode active material can then be added with additional agitation of 2 to 10 minutes. Additional solvent can be added with subsequent agitation to achieve a slurry with a viscosity suitable for coating. The slurry can be coated on the substrate (e.g., current collector) followed by drying. Drying can occur in an oven at, for example, 50 to 120° C. and/or under vacuum.

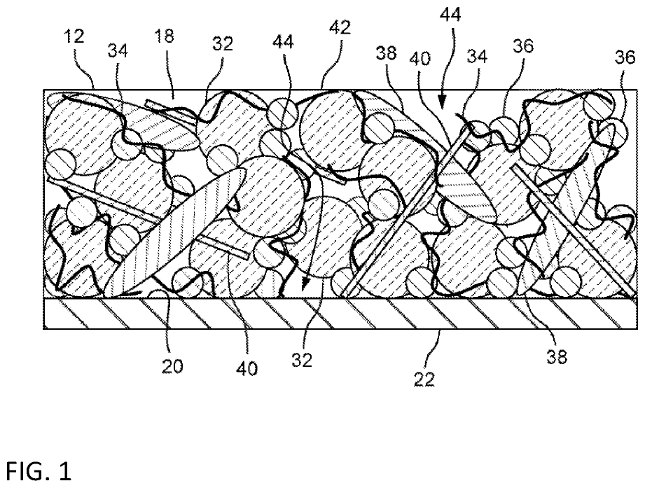

In accordance with an exemplary embodiment, as shown in FIG. 1, the cathode 12 includes a composite of active material particles 32, a binder 34, a dispersant (not shown), and a combination of electrically conductive additive types (36, 38, 40). In assembly, the cathode 12 is disposed on the major surface 20 of a current collector 22 in the form of a continuous uniform layer of material. The cathode 12 can include open pores 44 defined by the porous structure of the cathode 12 which can be infiltrated with an electrolyte 18. The cathode 12 can have a thickness, measured from the major surface 20 of the cathode current collector 22 to a facing surface 42 thereof, in a range of from 5 micrometers to 600 micrometers. The active material particles 32, the binder 34, the dispersant, and the combination of electrically conductive carbon additive types are substantially homogenously distributed throughout the cathode 12 on the major surface 20 of a cathode current collector 22.

### Electrochemical Cell

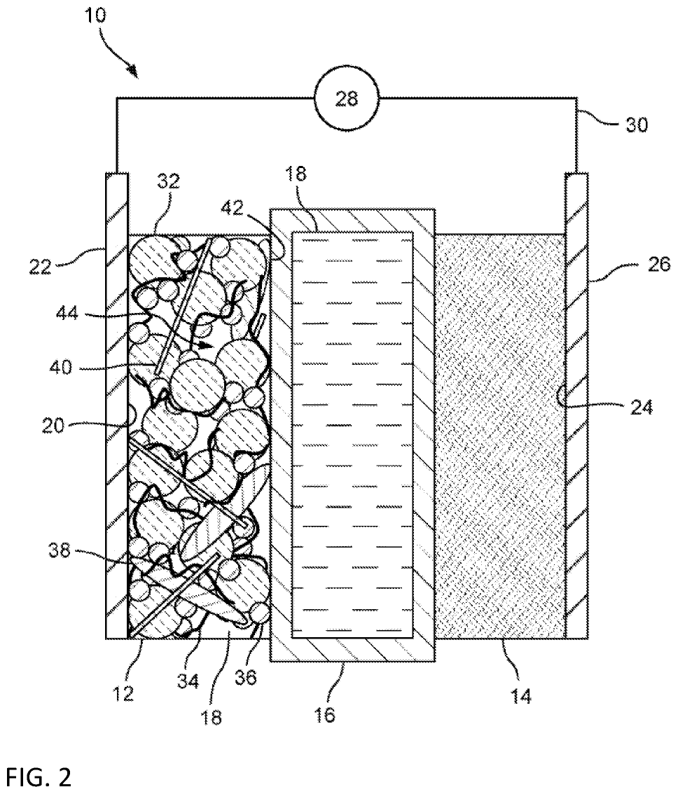

The cathode can be used in an electrochemical cell including the cathode, an anode, and an electrolyte. For example, as shown in FIG. 2, the electrochemical cell 10 can include a cathode 12, an anode 14 spaced apart from the cathode 12, and a porous separator 16 positioned between the positive and anodes 12, 14. The cathode and anode 12, 14 and the porous separator 16 are infiltrated with an electrolyte 18 that provides a medium for the conduction of lithium ions therethrough. The cathode 12 is disposed on a major surface 20 of a cathode current collector 22, and the anode 14 is disposed on a major surface 24 of an anode current collector 26. In practice, the cathode and anode current collectors 22, 26 may be electrically coupled to a power source or load 28 via an external circuit 30. The electrochemical cell 10 may be combined with one or more additional electrochemical cells to form a lithium-ion battery.

The anode 14 includes an active material. The active material can be, for example, graphite, a silicon-based graphite blend, or a silicon-based particle. The anode 14 can also include a binder. The binder can be the same or different than the binder for the cathode. The binder can include, for example PVDF, polyacrylonitrile (PAN), guar gum (GG), gum arabic (GA), polysaccharide lambda carrageenan (CGN), a cellulosic polymers such as carboxymethyl cellulose (CMC), sodium alginate (SA), polyimide (PI), polyvinyl alcohol (PVA), chitosan (CS), styrene butadiene rubber (SBR), polyacrylic acid (PAA), or ammonia polyacrylic acid PAA-NH3.

The anode 14 can include conductive elements such as carbon black, graphene, carbon nanotubes or combinations thereof.

The separator 16 can include, for example, a polymeric film, such as a polypropylene film or a coated polypropylene film.

The electrolyte 18 may include, for example, a metal salt, such as a lithiuim salt, dissolved in solvent(s) optionally with additional electrolyte additives. For example, the lithium salt may include lithium tetrafluoroborate (LiBF4), lithium hexafluorophosphate (LiPF6), lithium bis(flourosulfonyl)imide (LiFSI) or lithium bis(triflouromethanesolfonyl)imide (LiTFSI). The molarity can be 0.5 to 2 Molar. The solvent may include, for example, be ethyl methyl carbonate (EMC), ethylene carbonate (EC), fluoroethylene carbonate (FEC), diethyl carbonate (DEC), dimethyl carbonate (DMC), propylene carbonate (PC), polyethylene carbonate (PEC), vinyl carbonate (VC), trimethyl phosphate (TMP), sulfolane (SL), difluorobenzene (DFC), or a combination thereof. The electrolyte additive may include, for example VC, Lithium difluoro(oxalate)borate (LiDFOB), lithium diflourophosphate (LiDFP), FEC, Lithium bisoxalatoborate (LiBOB), prop-1-ene-1,3-sulfone (PES), ethylene sulfite (ES), succinonitrile (SCN), TMP, or tris(trimethylsilyl)phosphite (TMPi) or a combination thereof.

### EXAMPLES

### Example 1

Formulations were prepared by combining and mixing lithium rich (LMR) active particles having the formula Li[Li_{1/3-2x3}NiₓMn_{2/3-x/3}]O₂ wherein 0.3≤x≤0.4 PVDF as the primary polymer binder, furnace black having 65 m²/g surface area as the carbon black, graphene nanoplatelets having 65 m²/g surface area, single-wall carbon nanotubes having 400 m²/g surface area and an acid functional polymer with a sulfo-phenylated polyphenylene (sPPP) backbone composition in N-methyl-2-pyrrolidone (NMP) solvent at a combined solids weight of 60% based on total weight of mixture.

The specific formulations prepared are shown in Table 1. The conductive additives were first combined with NMP and milled for 10 minutes. The binder and dispersant polymer were added and mixed for another 5 minutes. The LMR particles were then added and mixed for another 5 minutes. Additional solvent was added and mixed for 10 minutes. This mixture was coated onto a current collector and dried.

Electrochemical cell including these cathodes of Formulations 1-3 and an anode (having silicon graphite active particles, a mixture of conductive elements and a water based binder), a polypropylene separator, and a high-voltage stable LiPF₆ based electrolyte (Electrolyte A) were prepared. These cells were charged to 4.6 V and discharged to 2 Volts twice (C-rate) of C/3 (charge or discharge over 3 hours for a full capacity battery) with a constant voltage. The C-Rate is the measurement of current in which a battery is charged and discharged.

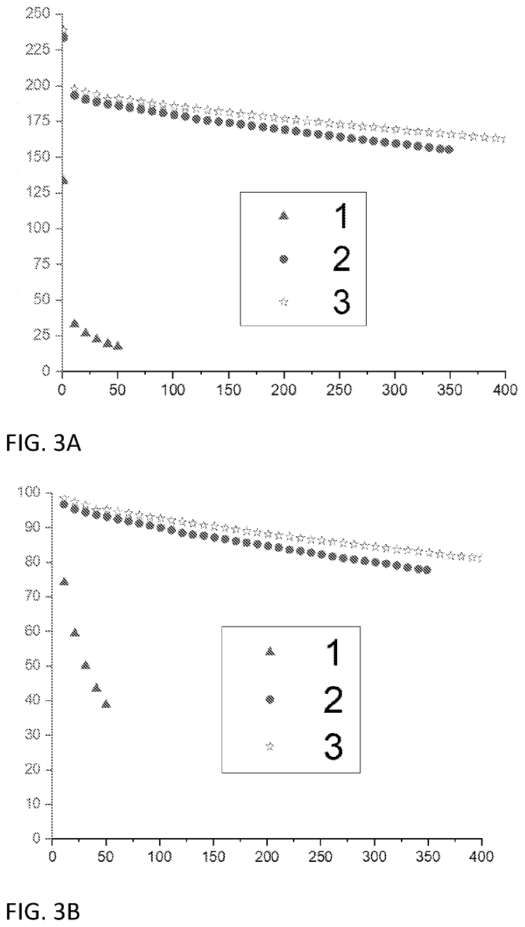

Cells were then and discharged to 2 volts at a C-rate of C/3 and evaluated for specific discharge capacity in milliamperes per gram [mAh/g] and discharge capacity retention. Discharge capacity retention was calculated by dividing each of the specific discharge capacity by the highest discharge capacity throughout cycling, cycled and evaluated for capacity and discharge retention. FIG. 3A shows the specific capacity in milliampere-hours per gram mass (mAh/g) on the y-axis and the cycle number on the x-axis. FIG. 3B shows the discharge retention (%) on the y-axis and the cycle number on the x-axis. Formulation 1 is represented by the triangles, formulation 2 by the circles and formulation 3 by the stars. Comparative Formulation 1 that includes only carbon black as the conductive additive shows a much more rapid decline in capacity and discharge retention compared to compositions having a mixture of conductive carbons as the conductive additive.

TABLE 1

| | | Wt. % | Wt. % | | | |
|---|---|---|---|---|---|---|
| | Weight % | Primary | Acid | Wt. % | Wt. % | |
| | Active | Polymer | Functional | Carbon | Graphene | Wt. % |
| Formulation | Material | Binder | Polymer | Black | Nanoplatelets | SWCNT |
| 1 | 97 | 1.5 | 0 | 1.5 | 0 | 0 |
| (comparative) | | | | | | |
| 2 | 97 | 1.2 | 0.3 | 0.8 | 0.6 | 0.1 |
| 3 | 97 | 1.0 | 0.25 | 1.05 | 0.6 | 0.1 |

### Example 2

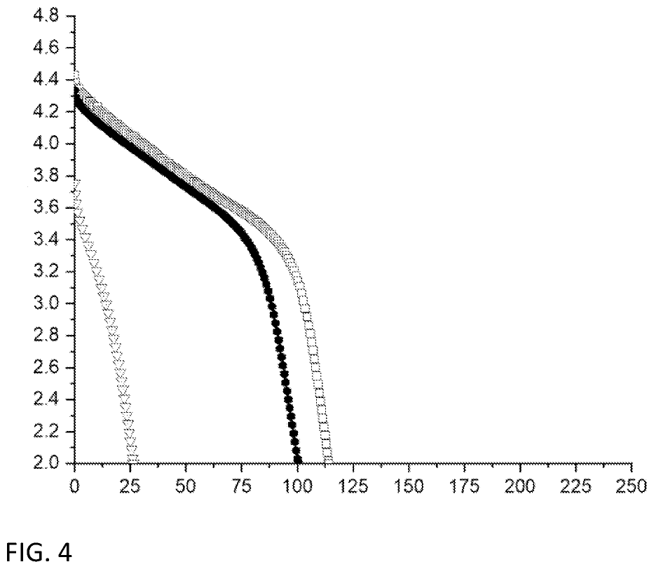

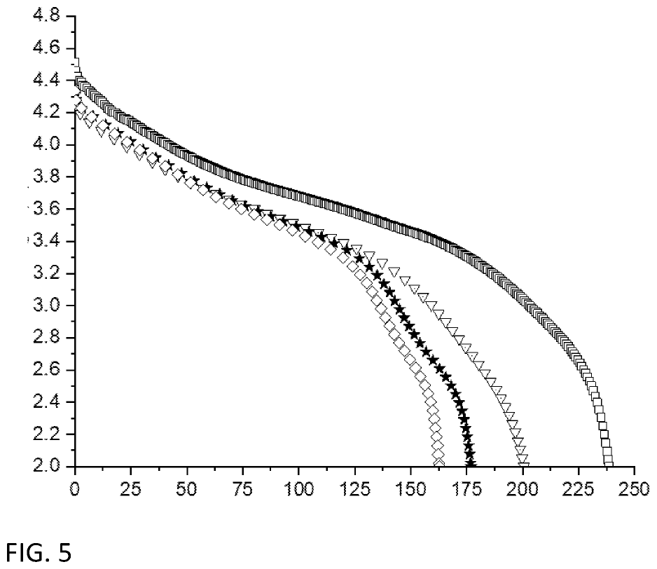

Electrochemical cells prepared as disclosed in Example 1 using Formulations 1 and 2 were evaluated for voltage decay during discharge. In FIG. 4 and FIG. 5, the y axis is Voltage (V) and the x-axis is capacity in milliampere-hours per gram mass (mAh/g). The voltage profile for Formulation 1 is shown in FIG. 4 for cycle 1 (square), cycle 2 (circle) and cycle 3 (triangle). The voltage profile for Formulation 1 is shown in FIG. 5 where cycle 1 is represented by a square symbol, cycle 3 by an inverted triangle symbol, cycle 200 by a star symbol and cycle 400 by a diamond symbol. As shown in FIGS. 4 and 5, Formulation 2 shows significantly better cycle stability than comparative Formulation 1.

### Example 3

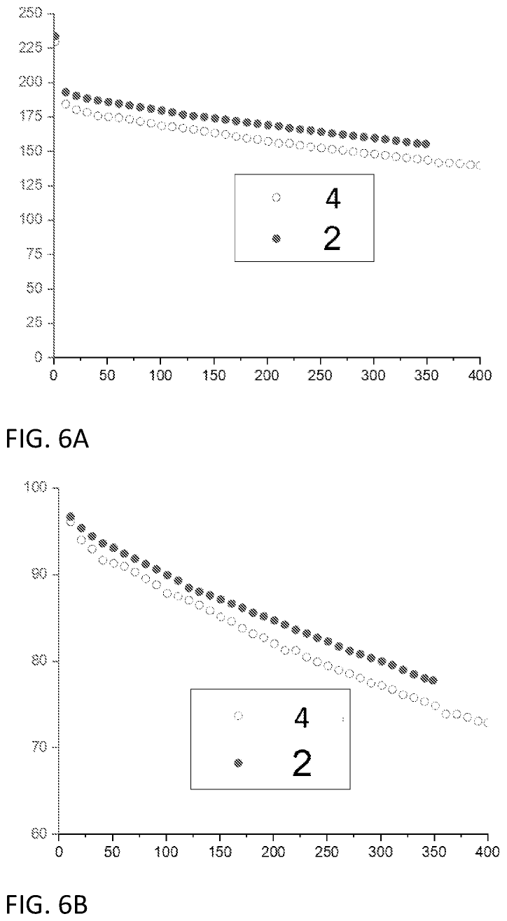

Electrochemical cells prepared as disclosed in Example 1 using Formulation 2 (1.2 wt % PVDF and 0.3 wt % of the acid functionalized polymer) and a comparative formulation 4 having 1.5% PVDF, but no dispersing polymer FIG. 6A shows the specific capacity in milliampere-hours per gram mass (mAh/g) on the y-axis and the cycle number on the x-axis. FIG. 6B shows the discharge retention (%) on the y-axis and the cycle number on the x-axis. Formulation 2 is represented by solid circles while comparative formulation 4 is represented by open circles. Both formulations include 0.1 wt % singe-wall carbon nanotubes, 0.8 wt. % furnace black, and 0.6 wt. % graphene nanoparticles. As shown in FIGS. 6A and 6B inclusion of the dispersing polymer in the binder system improves cycle life performance.

### Example 4

Electrochemical cells prepared as disclosed in Example 1 using Formulation 3, formulation 5 does not include graphene, formulation 6 omits the graphene uses a different carbon black and uses an acetylene carbon black from Denka and multi-wall carbon nanotubes from Cabot. Amounts are as shown in Table 2. The cells used a different Electrolyte B. Each formulation showed a discharge retention above 97% at 100 cycles.

| | | Wt. % | Wt. % | | Wt. % | | |
|---|---|---|---|---|---|---|---|
| | Weight % | Primary | Acid | Wt. % | Graphene | | |
| | Active | Polymer | Functional | Carbon | Nano- | Wt. % | Wt % |
| Formulation | Material | Binder | Polymer | Black | platelets | SWCNT | MWCNT |
| 3 | 97 | 1.0 | 0.25 | 1.05 | 0.6 | 0.1 | — |
| 5 | 97 | 1 | 0.25 | 1.4 | — | 0.1 | — |
| 6 | 97 | 1.0 | 0.25 | 0.58 | — | — | 1.17 |

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A cathode for use in a lithium ion battery, wherein the cathode comprises
an active material present in an amount of from 70 to 99 weight percent, wherein the active material comprises a lithium rich nickel manganese oxide;
a conductive network of a mixture of conductive elements present in an amount of from 0.25 to 20 weight percent, wherein the mixture of conductive elements comprises two or more of low aspect ratio particles, plate-like particles, and needle-like particles, and
a binder system present in an amount of from 0.25 to 10 weight percent, wherein the binder system comprises a primary binder polymer and an acid group or a salt thereof,
wherein the amounts are based on a total weight of the cathode.

2. The cathode of claim 1 wherein the lithium rich nickel manganese oxide has the formula xLi₂MnO₃*(1-x)LiMO₂; wherein 0<x≤0.5, M comprises Ni, Mn and optionally Co, and the mole ratio of Ni:Mn is in the range of 1:4 to 1:1.

3. The cathode of claim 1 wherein the mixture of conductive elements comprises the low aspect ratio particles in an amount 0.1 up to 10 weight percent, the plate-like particles in amounts from 0 up to 10 weight percent based on total weight of the cathode, and the needle-like particles in amounts from 0.05 up to 5 weight percent based on total weight of the cathode.

4. The cathode of claim 1 comprising 90 to 99 weight percent of the lithium rich nickel manganese oxide based on total weight of the cathode.

5. The cathode of claim 1 wherein the low aspect ratio particles are carbon black, the plate-like particles are graphene nanoplatelets, and the needle-like particles are carbon nanotubes.

6. The cathode of claim 1 wherein the low aspect ratio particles have an average particle size of 2 nanometers to 200 nanometers and an aspect ratio of 2:1 to 1:1.

7. The cathode of claim 1 wherein the plate-like particles have a thickness in a range of from 5 nanometers to 100 nanometers and a dimension orthogonal to thickness in a range from 1 to 25 micrometers.

8. The cathode of claim 1 wherein the needle-like particles have a length of from 0.1 up to 100 micrometers, and an aspect ratio of 10 to 5000.

9. The cathode of claim 1 wherein the active material further comprises up to 60% by weight of one or more additional metal oxides or phosphates.

10. The cathode of claim 9 wherein the additional metal oxides or phosphates are lithium manganese oxide (Li₍₁₊ₓ₎Mn₂O₄, where 0.1≤x≤1) (LMO), lithium nickel manganese oxide (LiNi_{0.5}Mn_{1.5}O₄) (LNMO), lithium cobalt oxide (LiCoO₂) (LCO), lithium nickel manganese cobalt oxide (LiNi_{1-x-y}CoₓMn_{y}O₂) (where 0≤x≤1 and 0≤y≤1) (NMC), lithium cobalt manganese aluminum oxide (LiNi_{1-x-y-z}CoₓMn_{y}Al_{z}O₂, where 0.0<x+y+z<0.25) (NCMA), lithium iron phosphate (LiFePO₄), lithium vanadium phosphate (LiVPO₄), lithium manganese iron phosphate (LiMn₁₋ₓFeₓPO₄, where 0≤x≤1) or a combination thereof.

11. The cathode of claim 5 wherein a portion of the conductive elements are functionalized with hydroxyl or carboxyl groups.

12. The cathode of claim 1 wherein the primary binder polymer comprises polyvinylidene fluoride.

13. The cathode of claim 1 wherein the acid group is carboxylic acid or sulfonic acid.

14. The cathode of claim 1 wherein the acid group is present in amounts of 0.05 to 10 milliequivalents per gram of binder system.

15. The cathode of claim 1 wherein the acid group is provided on an acid functional polymer distinct from the primary binder polymer.

16. The cathode of claim 15 wherein the acid group is present in an amount of 0.05 to 10 milliequivalents per gram of the acid functional polymer.

17. The cathode of claim 15 wherein the binder system comprises from 50 to 95 weight percent of primary binder polymer and from 5 to 50 weight percent of acid functional polymer based on total weight of the binder system.

18. The cathode of claim 16 wherein the acid functional polymer comprises an acid functionalized polymer polyvinylidene fluoride, (co)polymer or aromatic ionomer, sulfo-phenylated polyphenylene, a sulfonated derivate of poly(arylene ether), poly(arylene ether sulfone), poly(arylene sulfide), sulfonated polyimide, sulfonated polyphenylene, or combinations thereof.

19. The cathode of claim 1 comprising 90 to 99 weight percent of the lithium rich nickel manganese oxide which has a formula Li[Li_{1/3-2x/3}NiₓMn_{2/3-x/3}]O₂ wherein 0<x<0.5,
0.5 to 5 weight percent of the primary binder polymer,
0.1 to 1 weight percent of an acid functional polymer,
0.05 to 1 weight percent of the carbon nanotubes,
0.1 to 5 weight percent of the carbon black, and
0.1 to 3 weight percent of the graphene nanoplatelets, wherein the weight percent is based on total weight of the cathode.

20. An electrochemical cell comprising the cathode disposed on a current collector, an anode disposed on an anode current collector and an electrolyte wherein the cathode comprises
an active material present in an amount of from 70 to 99 weight percent, wherein the active material comprises a lithium rich nickel manganese oxide;
a conductive network of a mixture of conductive elements present in an amount of from 0.25 to 20 weight percent, wherein the mixture of conductive elements comprises two or more of low aspect ratio particles, plate-like particles, and needle-like particles, and
a binder system present in an amount of from 0.25 to 10 weight percent, wherein the binder system comprises a primary binder polymer and an acid group or a salt thereof,
wherein the amounts are based on a total weight of the cathode.
